(19) United States
(12) Patent Application Publication
(10) Pub. No.: US 2007/0247392 A1
(43) Pub. Date: Oct. 25, 2007

(54) Method for displaying private/secure data

(75) Inventor: Daniel J. Littrell, Carmel, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: INTERNATIONAL BUSINESS MACHINES CORPORATION, ARMONK, NY (US)

(21) Appl. No.: 11/409,347

(22) Filed: Apr. 21, 2006

(51) Int. Cl. G09G 5/00

(52) U.S. Cl. 345/8

(57) ABSTRACT

A system and method for allowing users to view secure data while excluding others from viewing. The method includes generating a stream of first data frames including secure data content to be viewed on a display device; inserting second data frames within the stream in a manner to thereby render a displayed image of the secure data unreadable on the display device. Shutter glasses, to be worn by an authorized user, are provided to receive signals from the computer device and, in response to received signals, filter out the second data frames thus enabling the viewer to view the secure data to the exclusion of nearby observers. The second frames are generated and interspersed within the first video frames having secure data by software executing on a conventional computing device. The second frames may include random text interspersed according to a regular or irregular pattern, or may include color and intensities to exploit deficiencies of human visual perception.

### FIELD OF THE INVENTION

This invention relates to data security systems generally, and more specifically, to a system and method for making sensitive data displayed on a display device more secure when it is being viewed.

### BACKGROUND OF THE INVENTION

As data processing systems become more portable, minimally invasive solutions become necessary to enable the secure viewing of sensitive data, e.g., when displayed on a mobile or portable computing device. For instance, a basic text document presented for display on a laptop computer may be observed by people in the vicinity of the laptop device, thus potentially compromising the security of the data displayed. An example of this is an employee viewing confidential electronic documents while on an airplane; it is desired that the employee be able to view the documents while neighboring people are excluded from viewing access.

Techniques such as described in U.S. Pat. Nos. 6,266,106 and 5,379,369 provide a solution that enables users to view 3 dimensional or stereoscopic images displayed on a computer device via a pair of liquid crystal shutter glasses. Such glasses are electronically coupled to the computer device and operate in synchrony with electronic signals generated by the computer to orient the crystals in the left eyeglass and right eyeglass in a manner so that the wearer of the glasses will be able to view stereoscopic images.

While use of “shutter glasses” as described in U.S. Pat. No. 6,266,106 provide a way of viewing stereoscopic images, that patent does not describe how to use shutter glasses for viewing secure data. To do this one would blank both eyes of the shutter glasses simultaneously, instead of alternating left and right eyes as is done for viewing of stereoscopic images.

It would be highly desirable to provide a novel display method for a device that is used for displaying and viewing private or secure textual data whereby a user of a device is able to visually observe sensitive data on a system, while other people in the same vicinity will be intentionally unable to read the displayed data.

It would further be highly desirable to provide a novel type of image display method for a small mobile or laptop computer or pervasive digital device that enables users to view private or secure data in a relatively simple and minimally invasive way.

### SUMMARY OF THE INVENTION

A system and methodology provides the secure viewing of data by a viewer to the exclusion of other viewers in proximity with or in the vicinity of the authorized viewer.

The system and method for displaying secure or private data of the invention is minimally invasive, in that it is usable on currently available hardware and only requires (1) special secure software component to be installed on the viewer's display device; and (2) the first viewer must wear some implementation of “shutter glasses”.

Thus, according to the invention, there is provided a system, method and computer program product for allowing certain users to view secure data while excluding others in the same vicinity. The method includes generating a stream of first data frames including secure data content to be viewed on a display device; inserting second data frames within the stream of first data frames in a manner to thereby render a displayed image of the secure data unreadable on the computer display device. Special shutter glasses are provided that are adapted to receive (wired or wireless) signals from the computer device. The shutter glasses, to be worn by a viewer of the secure data, are adapted to filter out the second data frames in response to received signals. The viewer may view the secure data to the exclusion of nearby observers viewing the display device.

The software component is installed on the viewer's display device and operates in conjunction with the video display system employed to provide special video frames that are viewable by a wearer of a special shutter glasses. The types of devices include any computing device, typically of any current stationary and mobile computing platform, e.g., such as a desktop, laptop or mobile computer, cell phone, pervasive device (personal digital assistant), etc. A novel implementation of a shutter glasses is employed in conjunction with the special displays generated.

In one embodiment, the software running on the host machine intersperses “phantom frames” along with the standard “true frames” so that a viewer without the shutter glasses would simply see a blurred and unreadable image. The software on the machine then synchronizes shutter glasses worn by the user so that they would be opaque when the phantom frames were displayed and transparent when the true frames were displayed. This would allow the wearer of the shutter glasses not to be bothered by the phantom frames and thus be able to view the secure data clearly.

In an alternate embodiment, the software running on the host machine intersperses “powerhouse frames” along with the standard “true frames” so that a viewer without the shutter glasses would simply see unreadable images that exploit sensitivities of the human perceptual system.

Advantageously, the present invention does not require a industry wide paradigm shift, but could rather be simply added on to existing systems. That is, the system is minimally invasive, in that it is usable on currently available hardware and only requires special secure software to be installed on the machine in question and the viewer to wear an implementation of shutter glasses.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 depicts the system and method 10 for displaying secure or private data of the invention; and,

FIG. 2 depicts an algorithm 50 encapsulated in software that is employed to render the displayed image on a compute device screen display as unreadable and unviewable to the person in the viewing vicinity of or proximate to the authorized user.

### DETAILED DESCRIPTION OF THE INVENTION, AND PREFERRED EMBODIMENTS THEREOF

The present invention is a system and methodology providing for the secure viewing of data by a viewer to the exclusion of other viewers in proximity with or in the vicinity of the viewer.

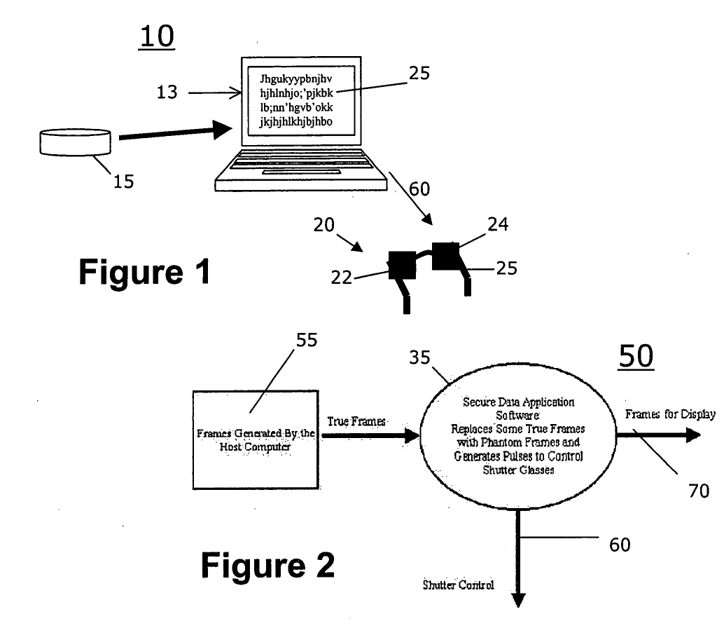

FIG. 1 depicts the system and method 10 for displaying secure or private data of the invention. As shown in FIG. 1, the system is minimally invasive, in that it is usable on currently available hardware such as a desktop computer, personal computer, laptop or mobile computer, 13, and only requires: (1) special secure software component 15 to be installed on the viewer's display device driver; and (2) employment of some implementation of “shutter glasses” 20, to be worn by the first viewer, of the kind such as described in U.S. Pat. No. 6,266,106 entitled “Liquid crystal shutter glasses having inclined liquid crystal glasses” by Haruhiko Murata, et al. the contents and disclosure of which is incorporated by reference as if fully set forth herein.

To display plain text in a secure manner, the system is designed that would make this text unreadable to a viewer not wearing shutter glasses 20, while at the same time preserving readability for the intended user. FIG. 2 depicts an algorithm 50 encapsulated in the software component 15 that is employed to render the displayed image 25 on the screen display provided by computing device 13 as unreadable and unviewable to the person in the viewing vicinity of or proximate to the authorized user for who the secure text is intended. Specifically, as shown in FIG. 2, at the software application functions to generate phantom frames that are caused to be interspersed with true frames 55 containing the secure data to be viewed at a predefined rate by the computer display device 13. In one embodiment, phantom frames 55 that are caused to be interspersed with true images at a rate of 2 to 1. That is, for every one (1) true frame (containing the secure data/text to be viewed), two (2) phantom frames would be displayed. These phantom frames would be generated by the application software component (FIG. 1) installed on the computer.

It is understood that the phantom frame is of the type that is successful in obscuring text based images. One style of phantom frame implemented for obscuring text based images is built by generating random text of the same font as the true image. When the phantom frames of random text are interspersed with true frames at a rate of 2 to 1, the resulting display 25 (FIG. 1) becomes illegible. When the phantom frames are hidden from a user's view, as is the case when a user wears shutter glasses, the true text is not obscured.

Referring back to FIG. 1 and as described in U.S. Pat. No. 6,266,106, the liquid crystal (LC) shutter glasses 20 includes a right eyeglass portion 22 comprising liquid crystal material for a right eye and a left eyeglass portion 24 including liquid crystal material for a left eye that are part of, or mounted to, a frame 25. Within the frame is a receiver for receiving signals 60 from the computer device for providing left eyeglass and right eyeglass shutter control according to the invention. The glasses are equipped with a signal processing device (not shown) that effectively applies a control voltage to the left and right eyeglasses in response to received signals 60 to control eyeglass shutter action, i.e., make liquid crystal for a right eye 22 and liquid crystal for the left eye 24 shut for a predetermined duration, preferably corresponding to the duration of a displayed video frame. A cell chamber (not shown) may be provided in which a small power supply source may be provided for supplying power to the signal processing device, and voltage for the liquid crystal for a right eye, and liquid crystal for a left eye. It should be understood that the shutter glasses may be designed to receive electronic signals from the computing device via a physical wired connection, or wireless connection (e.g., Bluetooth, Infrared, RF). The control signal effectively causes the right and left LC eyeglass portion to block light therethrough so that the phantom frames are filtered out (not seen by the wearer of the device).

Thus, in further view of FIG. 2, video processing functionality 35 provided in the computing device is caused to generate control pulses for controlling the shutter glasses in synchrony with the generation of the phantom frames. That is, shutter control pulses 60 are generated by the secure data application software to provide shutter control of the glasses so that only the viewer of the display wearing control shutter glasses will view the frames 70 meant for display. Thus, for example, each of the interspersed phantom frames are marked or tracked within the system software so that the video processing device will generate a control pulse when a phantom frame is caused to be displayed. This control pulse is sent to the shutter glasses to precisely filter out the display phantom frame and is be of a duration approximately equal to the duration of a displayed frame. The control pulses are sent out in such a way that the glasses will be opaque while the phantom frames are displayed and clear at other times.

In other implementations of the present invention, the secure data is desired to be displayed has a refresh rate above a critical threshold. Defining this threshold to be the point “X” where the user is not bothered by flicker when the display is set to a refresh rate of “X/2”; that is, one could divide the refresh rate in half and still have a system that is adequate for viewing. In this case, when the monitor is set to have a refresh rate at “X” or above, the secure data software may use (on average) half of the displayed frames for phantom frames and the other half for true frames. An observer without the shutter glasses, whose eyes by nature try to integrate the total sequence of frames presented, can easily be made to see and unreadable image when presented with the phantom and true frames. Since the secure viewer does not see the phantom frames, as they are blocked by the precisely timed shutter glasses, the perceived image on the screen is undistinguishable from the original “unsecured” image. To further enhance security, the software could also vary in time the displaying of phantom and non-phantom images so that they are not on a regular pattern. In this way, a dubious user with their own pair of shutter glasses would not be able to view the secure data, unless those glasses were able to follow the special pattern of phantom/true frame displaying. This pattern can be made in a variety of ways, and is simply used to add further security. Thus, in view of FIG. 2, control pulses are sent to the shutter glasses in synchrony with the implemented pattern to filter out viewing of the display phantom frames.

Implementing this invention on a system in which the refresh rate is too low to allow a significant amount of phantom frame insertion (such as current technology LCD) can be accomplished in the following manner: Instead of inserting many phantom frames, the software instead inserts very few “powerhouse frames”: frames that are meant to be powerful enough to overwhelm the viewing of the secure data. These powerhouse frames are meant to exploit the differences (inherent in the human visual system) between persistence of images with different colors and intensities. That is, certain colors/intensities make a larger visual impact on the viewer than others and therefore when time multiplexed with softer colors are able overwhelm them. For example, displayed powerhouse frames having a red color/tint/hue will overwhelm the green color receptors in the human eye thus, rendering displayed data in a “green” color font as unviewable. With this in mind, secure text would be displayed in a softer color and then powerhouse frames would be inserted at a rate so that the time varying image would appear unreadable. For a user to view the data, shutter glasses would be worn so that the powerhouse frames would be subtracted out as described above.

While the invention has been described herein with reference to specific embodiments, features and aspects, it will be recognized that the invention is not thus limited, but rather extends in utility to other modifications, variations, applications, and embodiments, and accordingly all such other modifications, variations, applications, and embodiments are to be regarded as being within the spirit and scope of the invention.

What is claimed is:

1. A method for viewing of secure data displayed on a computer display device comprising:
a) generating a stream of first data frames including secure data content to be viewed;
b) inserting second data frames within said stream of first data frames in a manner to thereby render a displayed image of said secure data unreadable on said computer display device; and
c) providing shutter glasses adapted to receive signals from said computer device, said shutter glasses to be worn by a viewer of said secure data and adapted to filter out said second data frames in response to received signals, wherein said viewer may view said secure data to the exclusion of nearby observers viewing said display device.

2. The method as claimed in claim 1, wherein said second data frames are interspersed with said first data frames at a ratio of X:1, where X>1.

3. The method as claimed in claim 2, wherein said second data frames are inserted in a stream of first data frames in a regular pattern.

4. The method as claimed in claim 2, wherein said second data frames are inserted in a stream of first data frames in an irregular pattern.

5. The method as claimed in claim 1, wherein said second data frames includes randomly generated text.

6. The method as claimed in claim 1, wherein said second data frames includes randomly generated text having an identical font as a text font of said secure data.

7. The method as claimed in claim 1, wherein said second data frames comprise content sufficient to exploit differences in image colors inherent in the human visual perception.

8. The method as claimed in claim 1, wherein said second data frames comprise content sufficient to exploit differences in image intensities inherent in the human visual perception.

9. The method as claimed in claim 1, further comprising:
generating, by said computer device, control signals corresponding in time to display said second data frames; and
receiving, by said shutter glasses, said control signals to subtract out said second data frames,
whereby a wearer of said glasses only view images comprising said second data.

10. A system for viewing secure data displayed on a computer display device:
means for generating a stream of first data frames including secure data content to be viewed;
means for generating second data frames and inserting second data frames within said stream of first data frames in a manner to thereby render a displayed image of said secure data as unreadable on said computer device; and
shutter glasses device to be worn by a viewer of said secure data, said shutter glasses device adapted to receive signals from said computer device for filtering out said second data frames in response to received signals, wherein said viewer may view secure data to the exclusion of nearby observers viewing said display device.

11. The system as claimed in claim 10, wherein said shutter glasses device receives signals via a wired connection.

12. The system as claimed in claim 10, wherein said shutter glasses device receives signals over a wireless connection.

13. The system as claimed in claim 10, wherein said shutter glasses device includes liquid crystal glasses.

14. The system as claimed in claim 10, further including means for interspersing second data frames with said first data frames at a ratio of X: 1, where X≧1.

15. The system as claimed in claim 14, wherein said second data frames are inserted in a stream of first data frames according to a predefined pattern.

16. The system as claimed in claim 10, wherein said second data frames includes randomly generated text at the same font size or different font size of said secure data.

17. The system as claimed in claim 10, wherein said second data frames comprise content sufficient to exploit differences in image colors and image intensities inherent in human visual perception.

18. A program storage device tangibly embodying software instructions which are adapted to be executed by a computing device to perform a method of viewing of secure data displayed on a computer display device according to claim 1.
